(19) United States
(12) Patent Application Publication
(10) Pub. No.: US 2008/0139096 A1
(43) Pub. Date: Jun. 12, 2008

(54) FOOD PREPARATION APPARATUS

(76) Inventor: Robert Limmer, Closter, NJ (US)

Correspondence Address: MEREDITH & KEYHANI, PLLC, 330 MADISON AVE., 6TH FLOOR, NEW YORK, NY, 10017, US

(21) Appl. No.: 11/609,878

(22) Filed: Dec. 12, 2006

(51) Int. Cl. A22C 7/00

(52) U.S. Cl. 452/146

(57) ABSTRACT

An apparatus for pounding a food item, the apparatus comprising: a bottom portion having four sides and a raised lip along three of the four sides; a top portion having four sides; an accordion hinge in communication with one of the four sides of the bottom portion and one of the four sides of the top portion, wherein the accordion hinge hingedly attaches the bottom portion to the top portion to provide an adjustable thickness between the top portion and the bottom portion.

The present invention relates to an apparatus for pounding fish, poultry, meat and other food items.

For many cooks and chefs it is desirable to be able to pound meat to a thinner or more uniform shape. Presently, plastic wrap and or plastic bags are utilized by placing the meat inside the bag or between the plastic wrap and pounding the meat. However, such apparatus are flawed in that the plastic wrap is too thin and frequently breaks. This can be particularly undesirable when pounding chicken or other food items that may contaminate the kitchen. The plastic bags are thicker and therefore somewhat tougher. However, they are too expensive to be used for each piece of meat. Another issue is that plastic bags are limited by the size of the bag. So, if you wish to pound to be larger than the size of the plastic bag, this is not possible.

Accordingly, the present invention provides a reusable, adjustable apparatus to be used to pound and thin meats, poultry, fish and other food items.

### SUMMARY OF THE INVENTION

The present invention relates generally to apparatus for food preparation.

According to one embodiment, an apparatus for pounding a food item is disclosed, the apparatus comprising: a bottom portion having four sides and a raised lip along three of the four sides; a top portion having four sides; an accordion hinge in communication with one of the four sides of the bottom portion and one of the four sides of the top portion, wherein the accordion hinge hingedly attaches the bottom portion to the top portion to provide an adjustable thickness between the top portion and the bottom portion.

According to another embodiment, an injection molded apparatus for pounding a food item, the apparatus comprising: a bottom portion having at least one side and a raised lip along the side; a top portion having at least one side and the same shape as the bottom portion; an attachment means in communication with one of the at least one sides of the bottom portion and one of the at least one sides of the top portion, wherein the attachment means attaches the bottom portion to the top portion to provide an adjustable thickness between the top portion and the bottom portion for the receipt of a food item.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

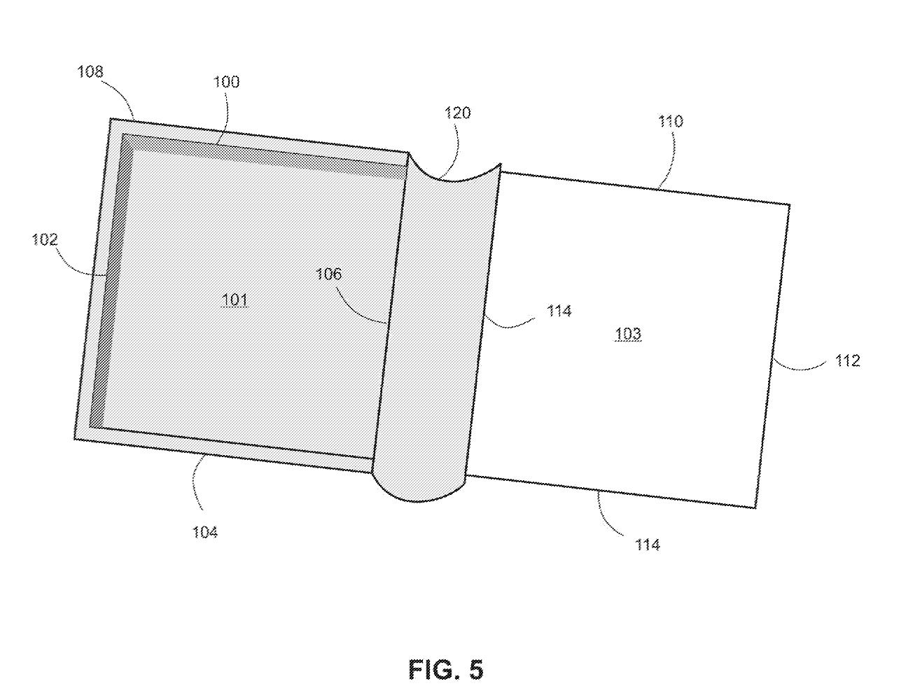

FIG. 6 depicts the present invention;

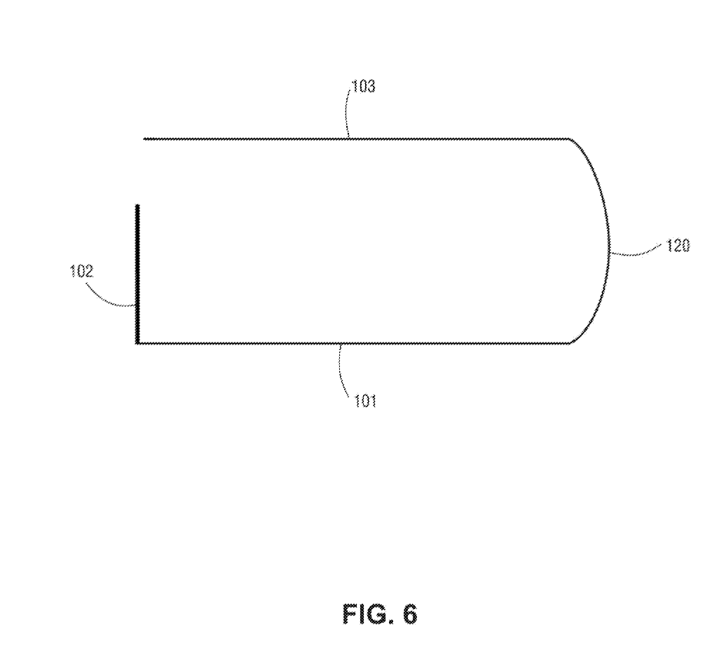

FIG. 7 depicts the present invention; and

FIG. 8 depicts the present invention.

### DETAILED DESRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

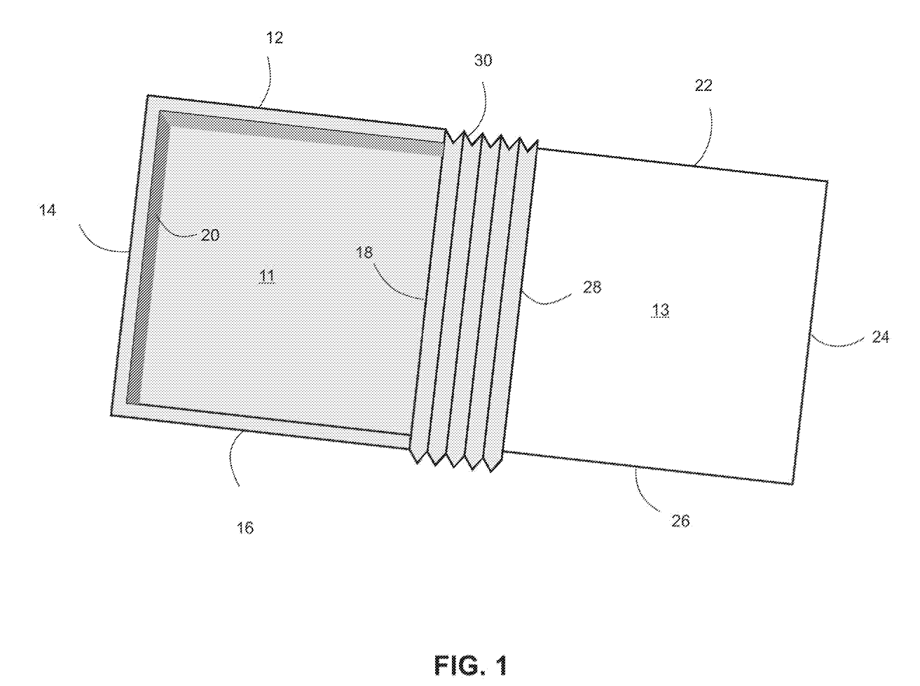

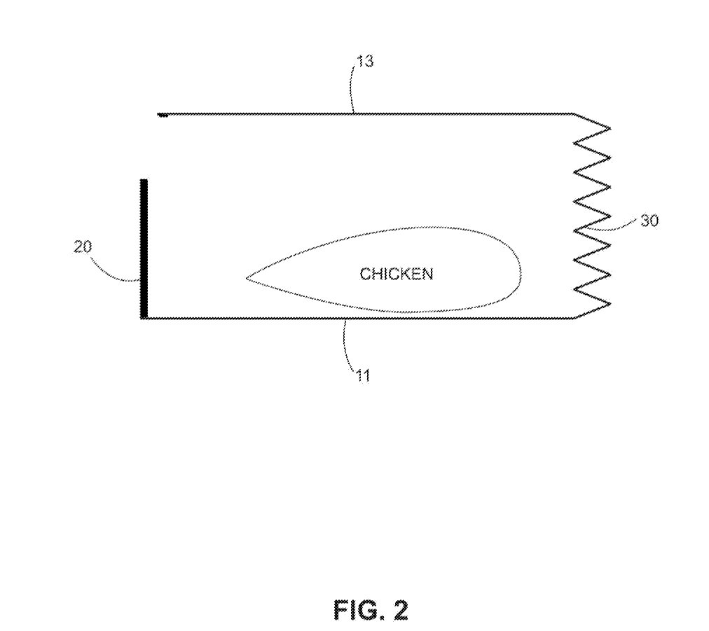

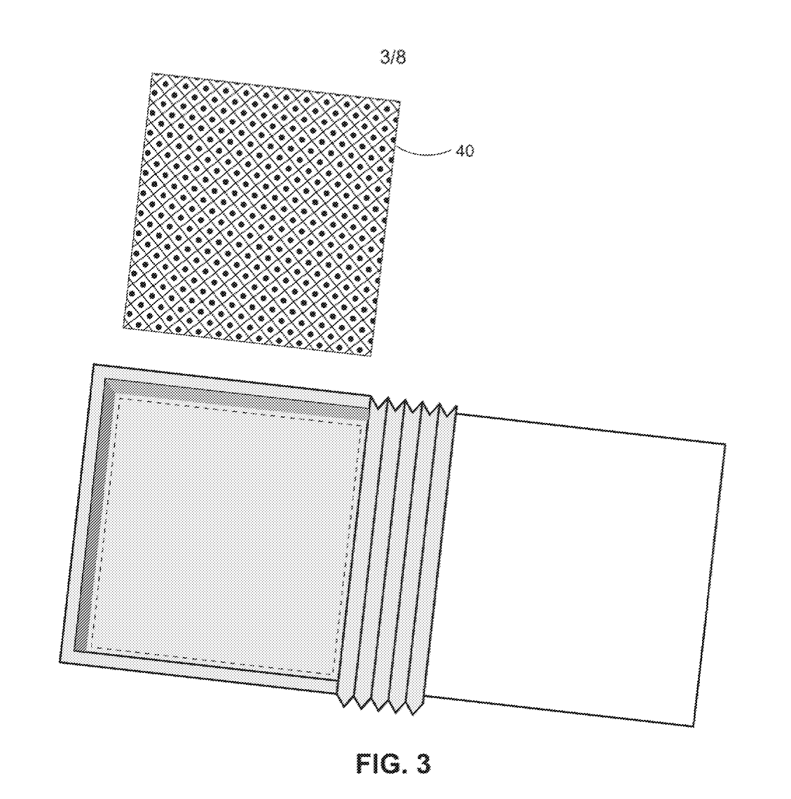

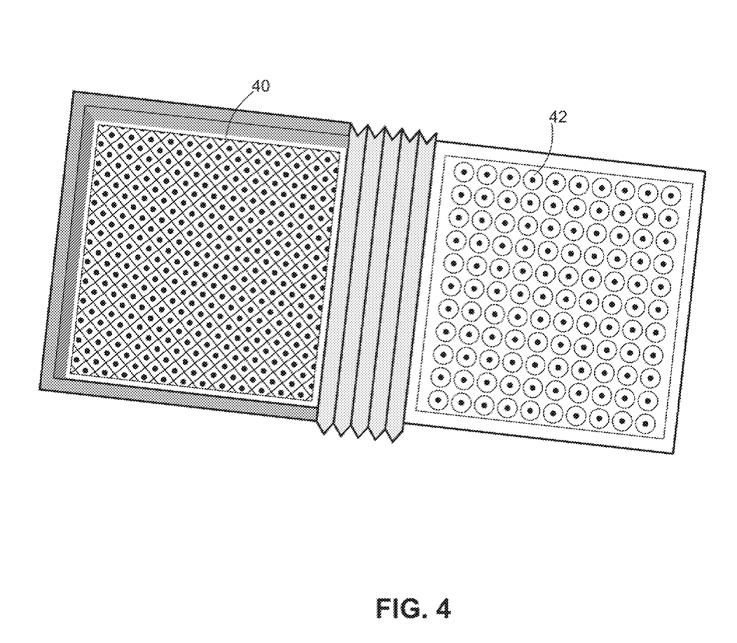

As shown in FIGS. 1-2, an apparatus for pounding a food item, the apparatus comprising: a bottom portion (11) having four sides (12, 14, 16, 18) and a raised lip (20) along three of the four sides (12, 14, 16); a top portion (13) having four sides (22, 24, 26, 28); an accordion hinge (30) in communication with one of the four sides (18) of the bottom portion (11) and one of the four sides (28) of the top portion (13), wherein the accordion hinge (30) hingedly attaches the bottom portion (11) to the top portion (13) to provide an adjustable thickness between the top portion (13) and the bottom portion (11). The top portion (13), the bottom portion (11) and the accordian hinge (30) may be made from polypropylene. The bottom portion's four sides (12, 14, 16, 18) may each be twelve inches in length and the top portions four sides (22, 24, 26, 28) may each be eleven and three quarters inches in length. The top portion (13), bottom portion (11) and attachment means (e.g. 30) may all be 50 millimeters thick. The apparatus may be formed from a single injection mold. As shown in FIGS. 3-4, there may be at least one textured plastic insert (40, 42). The textured plastic insert (40, 42) may be slightly smaller than the inside of the raised lip (20) of the bottom portion (11) and sits inside the raised lip (20) to provide textured pounding. The textured plastic insert (40, 42) may also sit on top of the food to be flattened and be in communication with the top portion (13).

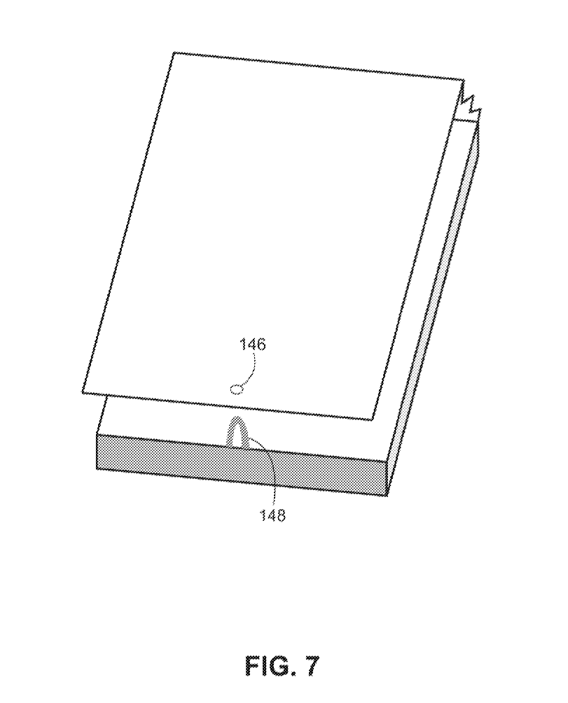

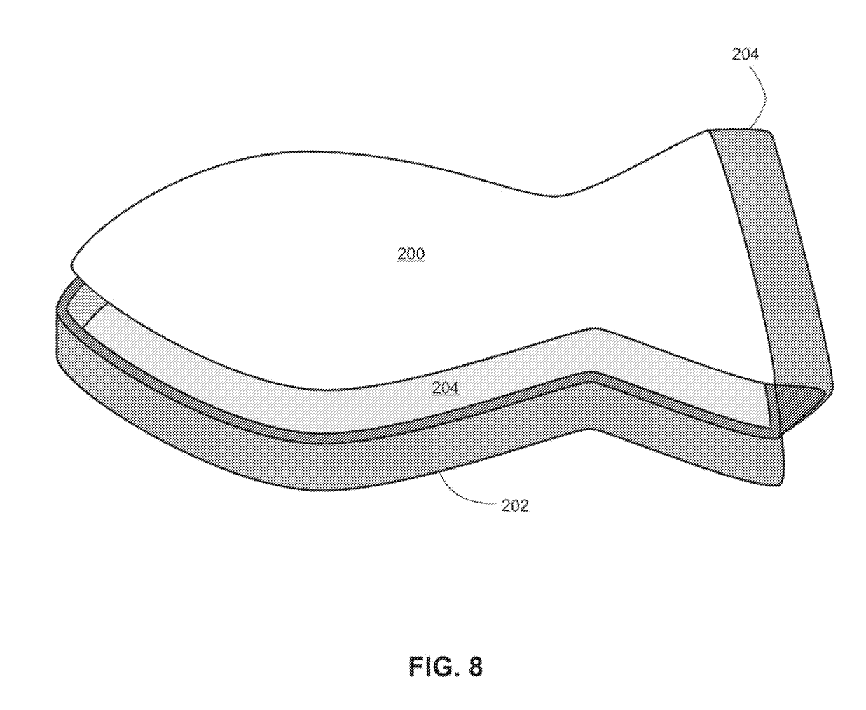

An injection molded apparatus for pounding a food item, the apparatus comprising: a bottom portion (101) having at least one side (100, 102, 104, 106) and a raised lip (108) along the at least one sides (100, 102, 104, 106); a top portion having at least one side (110, 112, 114, 116) and the same shape as the bottom portion (101); an attachment means (120) in communication with one of the at least one side (100, 102, 104, 106) of the bottom portion (101) and one of the at least one side (110, 112, 114, 116) of the top portion (103), wherein the attachment means (120) attaches the bottom portion (101) to the top portion (103) to provide an adjustable thickness between the top portion (103) and the bottom portion (101) for the receipt of a food item. The apparatus may be a variety of shapes including round, square, triangular, fish shaped and oval. FIG. 8 depicts a fish shaped apparatus having a top portion (200), bottom portion (204) lip portion (202) and attachment means (204). There may also be a closure means, such as that shown in FIG. 7 having a hook (146) and loop (148), which may be opposed to said attachment means (120). The top portion (103), bottom portion (101) and attachment means (120) may be made from polypropylene and may be approximately 50 millimeters thick. There may also be a textured plastic insert (40, 42) in any of the shapes, it should just be the same shape as the bottom portion and slightly smaller than the bottom portion and sits inside the raised lip to provide textured pounding. The texture may also be any variety of textures including raised spikes, wells, and any other texture.

It should be understood that the foregoing relates to preferred embodiments of the invention and that modifications may be made without departing from the spirit and scope of the invention as set forth in the following claims.

I claim:

1. An apparatus for pounding a food item, said apparatus comprising:
a bottom portion having four sides and a raised lip along three of said four sides;
a top portion having four sides;
an accordion hinge in communication with one of said four sides of said bottom portion and one of said four sides of said top portion, wherein said accordion hinge hingedly attaches said bottom portion to said top portion to provide an adjustable thickness between said top portion and said bottom portion.

2. An apparatus as in claim 1, further comprising a closure means, wherein said closure means is opposed to said accordion hinge.

3. An apparatus as in claim 1, wherein said top portion, said bottom portion and said accordian hinge are made from polypropylene.

4. An apparatus as in claim 3, wherein said top portion and said bottom portion are 50 millimeters thick.

5. An apparatus as in claim 1, further comprising at least one textured plastic insert.

6. An apparatus as in claim 9, wherein said textured plastic insert is slightly smaller than the inside of said raised lip of said bottom portion and sits inside said raised lip to provide textured pounding.

7. An apparatus as in claim 1, wherein said apparatus is formed from a single injection mold.

8. An apparatus as in claim 1, wherein said bottom portion's four sides are each twelve inches in length and said top portions four sides are eleven and three quarters inches in length.

13. An injection molded apparatus for pounding a food item, said apparatus comprising:
a bottom portion having at least one side and a raised lip along said at least one side;
a top portion having at least one side and the same shape as said bottom portion;
an attachment means in communication with one of said at least one side of said bottom portion and one of said at least one side of said top portion, wherein said attachment means attaches said bottom portion to said top portion to provide an adjustable thickness between said top portion and said bottom portion for the receipt of a food item.

14. An apparatus as in claim 13, further comprising a closure means, wherein said closure means is opposed to said attachment means.

15. An apparatus as in claim 13, wherein said top portion, said bottom portion and said attachment means are made from polypropylene.

16. An apparatus as in claim 13, wherein said top portion and said bottom portion are 50 millimeters thick.

17. An apparatus as in claim 13, further comprising at least one textured plastic insert.

18. An apparatus as in claim 17, wherein said textured plastic insert is slightly smaller than the inside of said raised lip of said bottom portion and sits inside said raised lip to provide textured pounding.

19. An apparatus as in claim 13, wherein said apparatus is formed from a single injection mold.

20. An apparatus as in claim 13, wherein said bottom portion and said top portion is formed to a specific shape and said specific shape is selected from the group consisting of round, square, triangular, fish shaped and oval.
